(19) United States
(12) Patent Application Publication
(10) Pub. No.: US 2007/0042800 A1
(43) Pub. Date: Feb. 22, 2007

(54) Mobile phone

(75) Inventor: Minako Tani, Daito-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/376,567

(22) Filed: Mar. 16, 2006

(30) Foreign Application Priority Data
Mar. 17, 2005 (JP) 2005-77823

(51) Int. Cl. H04M 1/00

(52) U.S. Cl. 455/550.1

(57) ABSTRACT

Provided is a mobile telephone that outputs new search results each time a user either selects a plurality of groups or changes a search condition. Each time new search results are outputted, a displayed size and coordinates of icons corresponding to parties found as the new search results are determined. The new search results are displayed according to the determined coordinates, after moving icons currently on display between a first area and a second area of a display, for example. Using the mobile telephone, the user is able to visually and easily recognize the process of increase/decrease in the number of search results.

This application is based on an application No. 2005-077823 filed in Japan, the content of which is hereby incorporated by reference.

### BACKGROUND OF THE INVENTION

(1) Field of the Invention

The present invention relates to a mobile telephone, and particularly relates to a technology suited for telephone book search.

(2) Related Art

Conventionally, there are various methods for searching for parties to be communicated with, using a telephone book installed in a mobile telephone. Representative examples are a group search and an incremental search (Please refer to Patent Reference 1 for details). Such search methods enable a user to find desired parties to be communicated with, and select one or more parties to start a call, send a mail, and so forth.

<Patent Reference 1>

Japanese Laid-open Patent Application No. 2002-152360

However, with the mentioned search methods, the number of parties displayed as a result of a search increases as the number of parties stored in a telephone book increases. The user then has to find desired parties from among the numerous parties on display every time he/she performs a telephone book search, to the nuisance of the user.

So as to solve this problem, there has already been a method of gradually reducing the number of candidates on display, by designation of a plurality of search conditions. However, it is natural that most mobile telephones have a certain size limit and that their display field accordingly has a size limit. Therefore, even with the stated method, it is still required to repeat designating search conditions, so as to reduce the number of candidates to be small enough to be accommodated in the display field and up to the level with which it is easy to find desired parties.

Moreover with such a conventional method, before the entire candidates are displayed in a search, a display typically only shows a part of the list of the candidates with the total number of candidates at the moment. With such a display not visually intuitive enough, the user would find it difficult to grasp the increase or decrease in the number of candidates as a result of designation of new search conditions, and further to decide when to stop designating search conditions, for finally selecting the parties to start actual communication.

### SUMMARY OF THE INVENTION

The present invention has been conceived in view of the stated problems, and has an object of providing a mobile telephone that allows a user to efficiently search for parties to be communicated with, and further to visually recognize the process of increase/decrease in the number of candidates in response to each search condition designation.

So as to solve the stated problem, a mobile phone of the present invention has a storage unit pre-storing therein pieces of attribute information in one-to-one relation with parties to be communicated with; a designation reception unit operable to receive, from a user, designation of a search condition for searching the pieces of attribute information; an extraction unit operable to extract, from the storage unit, one or more pieces of attribute information that satisfies the search condition; a display control unit operable to: when first designation is received, display on a predetermined area of a display, a first set of marks corresponding to pieces of attribute information extracted in accordance with the first designation; and when second designation is received succeeding the first designation, a) display on the predetermined area, a second set of marks corresponding to pieces of attribute information extracted in accordance with the second designation, and b) display in a predetermined display manner, and thereafter delete a third set of marks that correspond to a difference between the first set of marks and the second set of marks; and a selection information display unit operable to select, according to a user operation, any mark displayed on the predetermined area, and to display at least part of a piece of attribute information corresponded with the mark.

With the stated structure, even when a predetermined area of the display is limited in size, the user can visually recognize the process of increase/decrease in the number of candidates in response to each search condition designation.

In addition, the display control unit may display the first set of marks on a first area of the display, the second set of marks on the first area, and the third set of marks on a second area of the display that is outside the first area.

With the stated structure, the user is able to visually observe how marks, which correspond to candidates increased or decreased in number in response to a new search condition designation, move in or out a part of the display, and is accordingly able to easily grasp the increase or decrease in the number of candidates. Furthermore, the user is able to know the number of candidates still remaining in the search results by simply looking at the part of the-display.

In addition, a structure is also possible in which the storage unit stores the pieces of attribute information in association with one or more groups, respectively, designation received by the designation reception unit is selection of at least one group and a logical operator, and the extraction unit performs the extraction based on the at least one group and the logical operator selected by the designation reception unit.

With the stated structure, a search is performed by designating one or more groups as search conditions, which is simple for example compared to a search performed by inputting each character using a ten key to designate several search conditions. Furthermore, compared to a structure enabling selection of only one group, the stated structure is more efficient in finding out a plurality of parties belonging to a plurality of groups.

In addition, a structure is also possible in which the storage unit stores each of the pieces of attribute information in association with corresponding image data, and each mark displayed by the display control unit is image data stored in the storage unit in association with a corresponding piece of attribute information.

The stated structure displays a piece of attribute information using image data associated with a corresponding party. With the stated structure, it becomes possible to represent found attribute information in a manner easily recognizable to the user.

In addition, a structure is also possible in which the display control unit determines a displayed size of marks corresponding to pieces of attribute information extracted at one time, according to a number of the pieces of attribute information extracted at one time, and displays the marks in the determined size.

With the stated structure, it becomes possible to change the displayed size of marks according to the number of search results found at a time. Accordingly, the user is able to easily and visually recognize the determination process of the final search results, by observing how the displayed size of marks increases and decreases.

In addition, a structure is also possible in which the display control unit displays the first set of marks and the second set of marks respectively on the first area in one row, and moves the third set of marks between the first area and the second area as if the third set of marks is either departing from or joining the row. Another structure is also possible in which the display control unit displays the first set of marks and the second set of marks respectively on the first area in a circular formation, and moves the third set of marks between the first area and the second area as if the third set of marks is either departing from or joining the circle.

With the stated structures, when the number of search results has decreased, marks corresponding to the decreased portion are shown as if the marks are moving to the second area departing from the marks to remain in the first area. On the contrary when the number of search results has increased, marks corresponding to the increased portion are shown as if the marks are moving to join the marks already in the first area.

In addition, a structure is also possible in which each of the pieces of attribute information includes a name, a telephone number, and a mail address, as attributes of a corresponding party to be communicated with, and the selection information display unit displays, for each selected mark, at least one of a name, a telephone number, and a mail address.

With the stated structure, the user is able to recognize attribute information of a party corresponding to a selected mark, facilitating calling or mail transmission directed to the party, immediately after the search operations.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a functional block diagram showing the structure of a mobile telephone according to an embodiment of the present invention;

FIG. 2 is a diagram showing an operation unit 14;

FIG. 3 is a diagram showing a telephone book 300;

FIG. 4 is a diagram showing a group table 400;

FIG. 5 is a diagram showing a registration display 500 used by a user to register a new party to the telephone book 300;

FIG. 6 is a flowchart showing processing to search a telephone book and to sequentially output search results, performed by the search control unit 18;

FIG. 7 is a flowchart showing processing performed by the search control unit 18, from the first group selection and until another group selection or ending of a search;

FIG. 8 is a flowchart showing processing performed by the search control unit 18, when the user has selected a plurality of groups;

FIG. 9 is a flowchart showing processing performed by the display control unit 19 to display search results;

FIGS. 10A, 10B, and 10C respectively illustrate a search screen 1000 that the display unit 16 displays, in response to searching of a telephone book by a user;

FIG. 11 is a diagram showing a first area 105;

FIGS. 12A and 12B respectively illustrate a search result storage table 1200;

FIG. 13 is a flowchart showing processing performed by the display control unit 19 in response to the user's selection of the first group;

FIG. 14 is a flowchart showing processing to control a display method of icons, each time search results are outputted;

FIG. 15 is a diagram showing an attribute information display portion 106;

FIGS. 16A, 16B, and 16C respectively illustrate a search screen 1000; and

FIGS. 17A, 17B, and 17C respectively illustrate a search screen 1000.

### DESCRIPTION OF THE PREFERRED EMBODIMENTS

### Embodiment

The following describes a mobile telephone according to an embodiment of the present invention, with reference to related drawings.

<Structure>

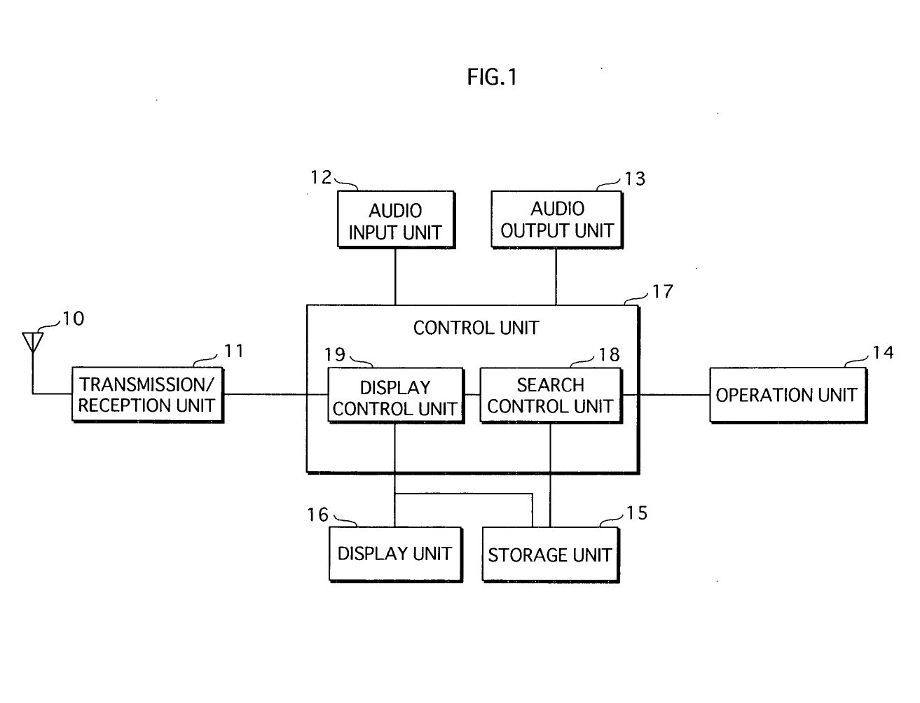

FIG. 1 is a functional block diagram showing the structure of a mobile telephone according to the present embodiment.

As shown in this drawing, the mobile telephone is equipped with an antenna 10, a transmission/reception unit 11, an audio input unit 12, an audio output unit 13, an operation unit 14, a storage unit 15, a display unit 16, and a control unit 17, where the control unit 17 includes therein a search control unit 18 and a display control unit 19.

The antenna 10 is a rod antenna that transmits and receives a communication radio wave, the antenna 10 being freely loaded and unloaded to/from the mobile telephone.

The transmission/reception unit 11 is a wireless circuit for transmitting and receiving a wireless signal, and performs transmission/reception of communication data conveyed as a communication radio wave. The transmission/reception unit 11 modulates communication data outputted from the control unit 17, and transmits the modulated communication data via the antenna 10. The transmission/reception unit 11 also demodulates communication data received via the antenna 10, and outputs the demodulated communication data to the control unit 17. Here, the communication data is specifically audio data used in telephone conversations, electronic mail data, image data, and the like.

The audio input unit 12 is a microphone, which converts inputted sound (e.g. voice of a user) into an audio signal, and outputs the audio signal to the control unit 17.

The audio output unit 13 is a speaker, which performs various audio output directed to a user, by outputting conversational voices or the like based on audio signals received from the control unit 17.

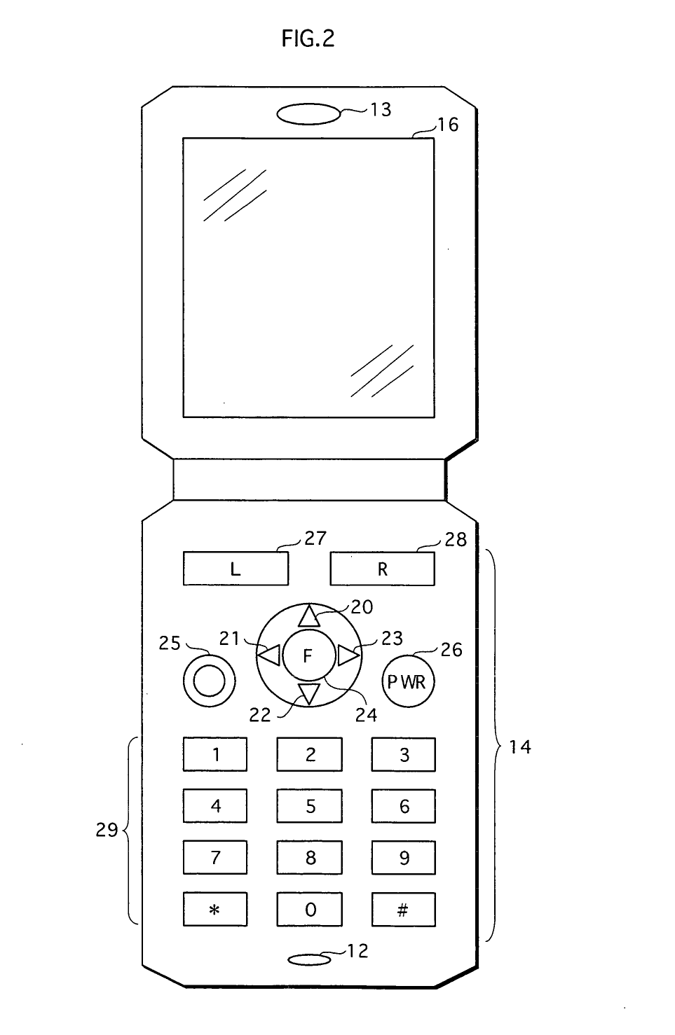

FIG. 2 is a diagram showing the operation unit 14 of the mobile telephone according to the present embodiment. As shown in this drawing, the operation unit 14 has an up key 20, a left key 21, a down key 22, a right key 23, a function key 24, a communication start key 25 used for initiating conversational communication, or used in PTT (Push-To-Talk) communication, a communication end key 26, a left soft key 27, a right soft key 28, and a ten key 29. The described keys are used to receive key input performed by a user, and to output signals to the control unit 17.

The storage unit 15 is a rewritable nonvolatile memory. The storage unit 15 stores therein a telephone book 300 used for search of parties to be communicated with, a group table 400 in which each group name is associated with a corresponding group number, search results outputted from the search control unit 18, and so on.

The display unit 16 is a liquid crystal panel, and performs various displays such as a search screen, an operation menu, character information, images, and a current time, based on signals received from the control unit 17.

The control unit 17 is equipped with a CPU (Central Processing Unit), a ROM (Read Only Memory), a RAM (Random Access Memory), and the like, and performs processing such as communication with a base station, communication initiation processing, and PTT communication processing, according to the program stored in the ROM.

The search control unit 18 is contained in the control unit 17, and controls processing for finding parties to be communicated with from the telephone book 300 stored in the storage unit 15. Every time a communication party search is performed, the search control unit 18 outputs found pieces of attribute information as search results, and have the storage unit 15 store the outputted search results.

The display control unit 19 is also contained in the control unit 17, and controls such processing as processing to display, a telephone-book search screen, the outputted search results, and the like, to the display unit 16.

<Data>

As follows, the telephone book 300 stored in the storage unit 15 is described.

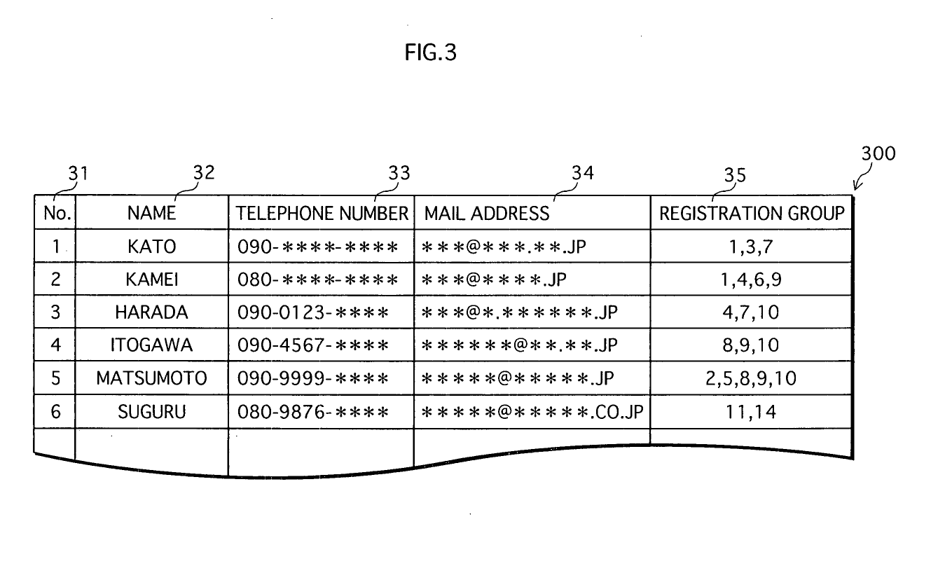

FIG. 3 is an illustration of the telephone book 300.

As shown in this drawing, the telephone book 300 contains items of: address 31 indicating a position in which particular information is stored in the storage unit 15; name 32; telephone number 33; mail address 34; and registration group 35.

The name 32 is information identifying a party. Examples thereof are a name of a person, and a name of a group.

The telephone number 33 indicates a telephone number of a party.

The mail address 34 indicates a mail address of a party.

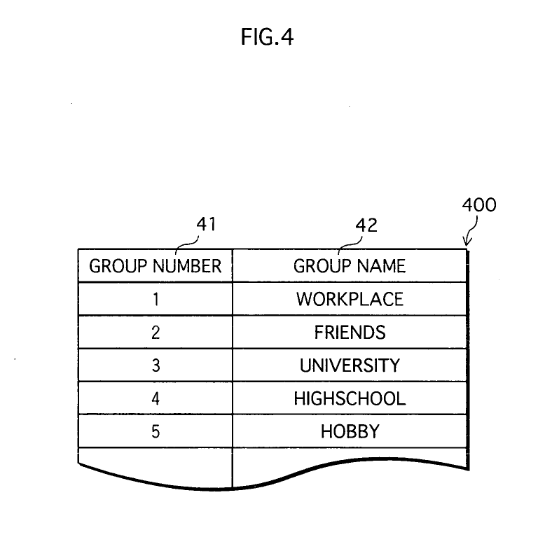

The registration group 35 contains a plurality of number of group numbers in which a party belongs to. In the example of FIG. 3, a person having the name 32 of “Kato” is shown to belong to three groups having the group numbers 35 of “1”, “3”, and “7”. Note that the user can assign a name to a group, and the assigned name is stored in a group table 400 (see FIG. 4) in the storage unit 15, as a group name 42.

FIG. 4 is an illustration of the group table 400.

As shown in this drawing, the group table 400 contains items of: group number 41; and group name 42.

The group number 41 indicates a group number.

The group name 42 is a list of names each assigned by a user to a respective group number of the group number 41. In the example of this drawing, the group number 1 represents a group named “workplace”, and the group number 2 represents a group named “friends”.

<Method for Registering a Plurality of Groups>

As can be seen from the registration group 35 of the telephone book 300, the telephone book 300 is able to store a plurality of group numbers for one party, in accordance with a user's registration. The concrete method of registering a plurality of group numbers for one party is explained as follows using the related drawing.

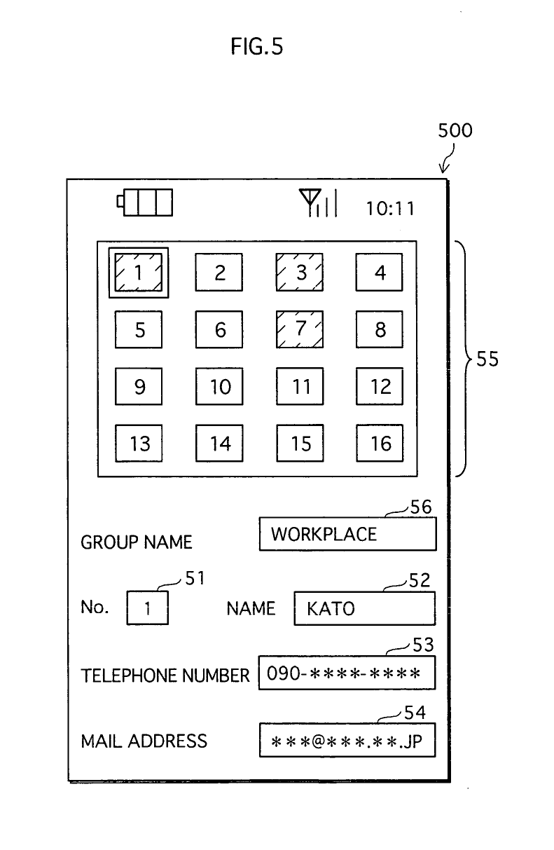

FIG. 5 shows a registration display 500 used by a user to register a party to the telephone book 300.

The registration display 500 contains an address setting box 51; a name setting box 52; a telephone-number setting box 53; a mail-address setting box 54; a group setting portion 55, and a group-name display box 56. The address setting box 51 is used to set the address No. 31 of the telephone book 300. The name setting box 52 is used to set the name 32. The telephone-number setting box 53 is used to set the telephone number 33. The mail-address setting box 54 is used to set the mail address 34. The group setting portion 55 is used to set the registration group 35. The group-name display box 56 is used to display the group name 42 assigned to a group number of a user's selection.

When, for example, the user enters a name and a mail address respectively to the name setting box 52 and the address setting box 54 using the operation unit 14, the entered name and mail address will be registered to the telephone book 300 under the items of name 32 and mail address 34.

The registration group 35 is set using the group setting portion 55. A concrete method therefor is explained as follows. The user moves a cursor to a group number desired to be registered for the particular party, by pushing the up key 20, the left key 21, the down key 22, and the right key 23. The group number that the cursor is currently indicating is displayed larger than the other group numbers, so as to distinguish the group number from the other group numbers.

In the example of FIG. 5, the cursor is indicating the group number 1, and so the group number 1 is displayed larger than the other group numbers. Simultaneously, the group-name display box 56 displays a group name stored under the group name 32 in correspondence with the group number 1. By performing a group deciding operation (e.g. pushing the function key 24) while the cursor is indicating the group number 1, the group number 1 is registered under the item of group number 35.

Once a group number has been registered by means of the group setting portion 55, the registered group number will be highlighted. In the example of FIG. 5, the group numbers 1, 3, and 7 are highlighted, meaning that these groups have been registered for a party.

<Operation>

As follows, an operation performed by a mobile telephone having the above-stated structure is described.

A user searches the telephone book for desired parties (search results). The telephone book is operable to store attribute information containing various attributes of a party such as the name 32, the telephone number 33, and the mail address 34 stored in the telephone book 300.

The control unit 17 receives a user operation for selecting a group via the operation unit 14, has the search control unit 18 search the telephone book 300 stored in the storage unit 15, and outputs the pieces of attribute information found in the search to have the storage unit 15 store the found pieces of attribute information.

The user is able to indicate a search condition when searching the telephone book. Here, the search condition is for example: a normal search to search for parties included in a selected group, a NOT search to search for parties not included in a selected group, an AND search to search for parties included in both of already found search results and a selected group, and an OR search to search for the parties included in at least one of already found search results and a selected group.

Search conditions are combinable. For example, suppose a case where a user has selected three groups of groups 1, 3, and 7. In this case, it is possible to combine search conditions as {(group 1)∩(group 3)}∪(group 7). It is also possible to combine an AND search (or an OR search) with a NOT search (e.g. a search for parties that belong to both of the groups 1 and 3, but do not belong to the group 7).

Every time a search result is outputted using a logical expression that is in accordance with the search condition, the display control unit 19 extracts the search result, and displays the search result to the display unit 16.

<Processing for Searching the telephone Book>

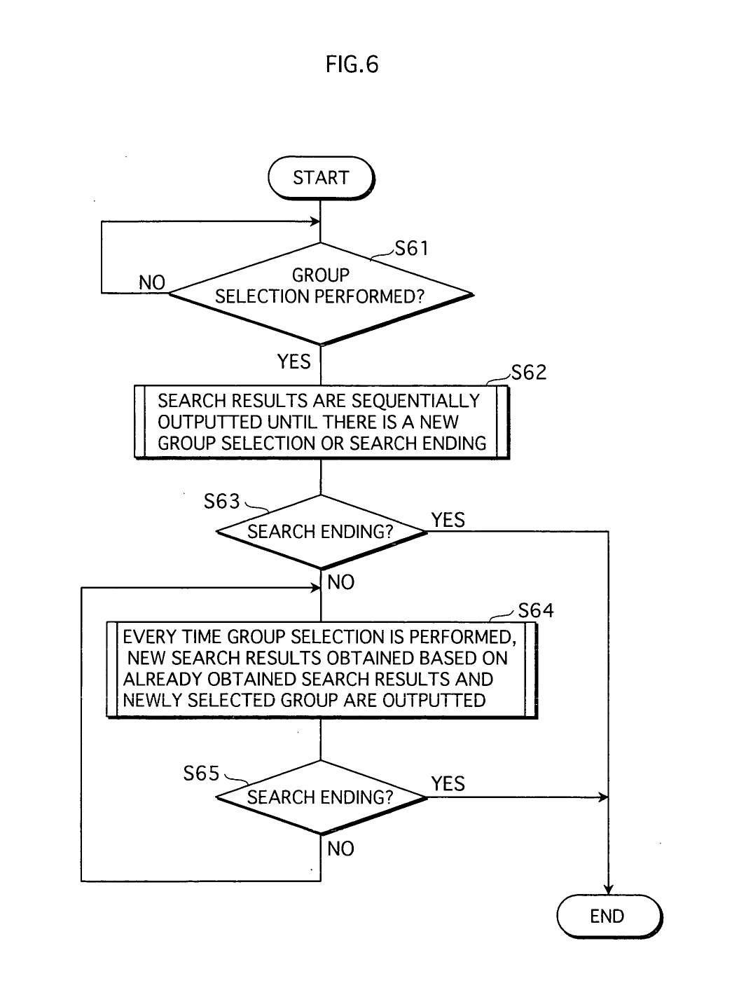

FIG. 6 is a flowchart showing processing to search the telephone book and to sequentially output search results, performed by the search control unit 18.

When a user initiates an operation to search the telephone book, the search control unit 18 first receives an operation from a user to select the first group (Step S61). When the first group has been selected (Step S61:YES), search results are sequentially outputted according to a search condition, until a new group (the second group) is selected or until the user performs an operation to end the search (Step S62). When the user indicates to end the search in Step S62 (Step S63: YES), the search control unit 18 ends the processing for searching the telephone book.

When the user has selected the second group, without indicating to end the search (Step S63:NO), new search results are outputted, where the new search results are specifically obtained by pursuing search according to the search condition directed to the whole of the newly selected group (the second group) and the already outputted search results prior to the selection of the new group (Step S64). Until the user selects another group or ends the search, the new search results continue to be outputted. Thereafter, while search is not indicated to end (Step S65:NO), every time the user selects a new group, new search results that satisfy the search condition are outputted based on the search results having been outputted so far and the newly selected group (Step S64). When the user finally indicates to end the search in Step S64 (Step S65: YES), the search control unit 18 ends the processing for searching the telephone book.

<Processing Performed for First Group>

As follows, the processing performed by the search control unit 18 in Step S62 is explained in detail using related drawings.

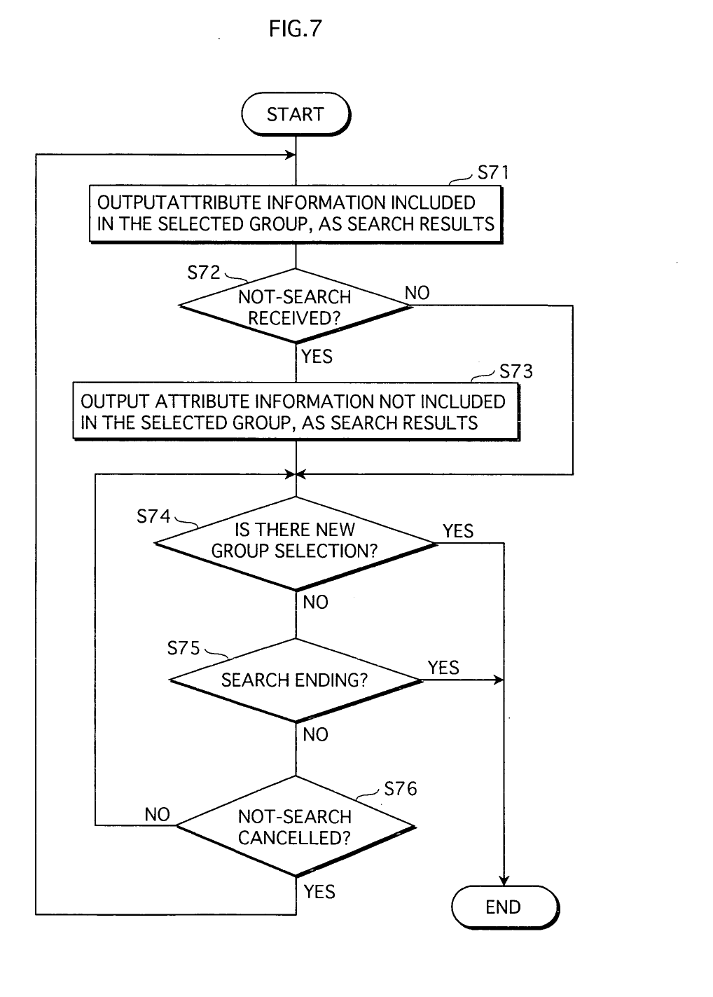

FIG. 7 is a flowchart showing processing performed by the search control unit 18 from the first group selection by a user and until another group selection or ending of a search (corresponding to Step S62 of FIG. 6).

When the user selects the first group, the search control unit 18 outputs pieces of attribute information included in the selected first group, as search results (Step S71). Here, when the user has indicated a NOT search as a search condition (Step S72:YES), pieces of attribute information not included in the selected first group is outputted as search results (Step S73). Every time there is a change in search condition (Step S76), new search results that satisfy the changed search condition are outputted (Steps S71, S73) for a duration (Step S74:NO, Step S75:NO) before the user selects a new group (second group) (Step S74:YES) or ends the search (Step S75:YES).

<Processing Performed for Second Group>

As follows, the processing performed by the search control unit 18 in Step S64 is explained in detail using related drawings.

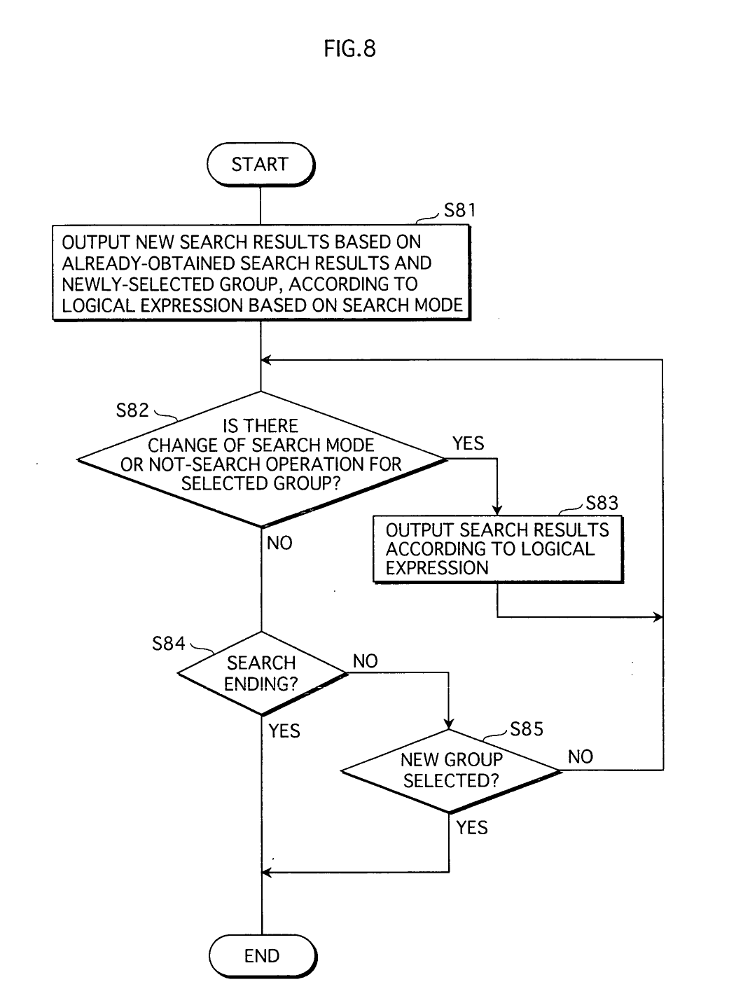

FIG. 8 is a flowchart showing processing performed by the search control unit 18, when the user has selected a plurality of groups. In this example, the plurality of groups are the first group and the second group (new group).

When having received an operation to select a plurality of groups from a user via the operation unit 14, the search control unit 18 outputs new search results obtained using the search results having been outputted prior to the second group selection, the newly-selected second group, and according to a logical expression being a combination of an AND search, a NOT search, and the like (Step S81).

When the user has changed the search condition (Step S82:YES), the search control unit 18 outputs new search results obtained using the already outputted search results, the newly-selected second group, and according to a logical expression incorporating therein the change in the search condition (Step S83).

Thereafter, for a duration (Step S84:NO and Step S85:NO) before the user ends the search (Step S84:YES) or selects a new group (Step S85: YES), every time there is a change in search condition (Step S82:YES), new search results obtained using the search result having been outputted so far and according to a logical expression incorporating therein the change in the search condition. When another group is selected (Step S85:YES), processing of Step S64 is performed again.

In this way, the search control unit 18 outputs new search results every time there is a new group selection or there is change in search condition.

<Processing to Display Search Result>

Every time new search results are outputted, the display control unit 19 performs processing to display the search results to the display unit 16.

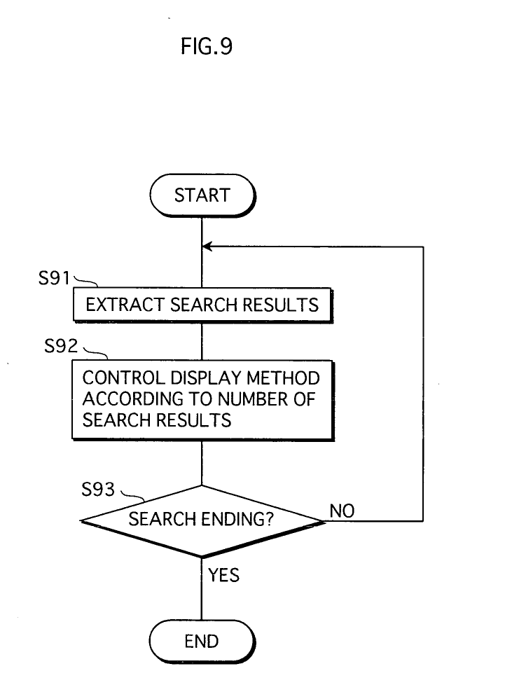

FIG. 9 is a flowchart showing processing to display search results.

The display control unit 19 extracts search results from the storage unit 15 (Step S91), the search results having been stored in the storage unit 15 by the search control unit 18. According to the number of the extracted search results, the display control unit 19 decides the manner in which the display unit 16 displays the search results, and displays the search results according to the decided method (Step S92). Thereafter, before the user ends the search (Step S93:NO), every time new search results are outputted, the display control unit 19 controls processing to extract corresponding search results, and to have the display unit 16 display the newly extracted search results.

<Search Result Display>

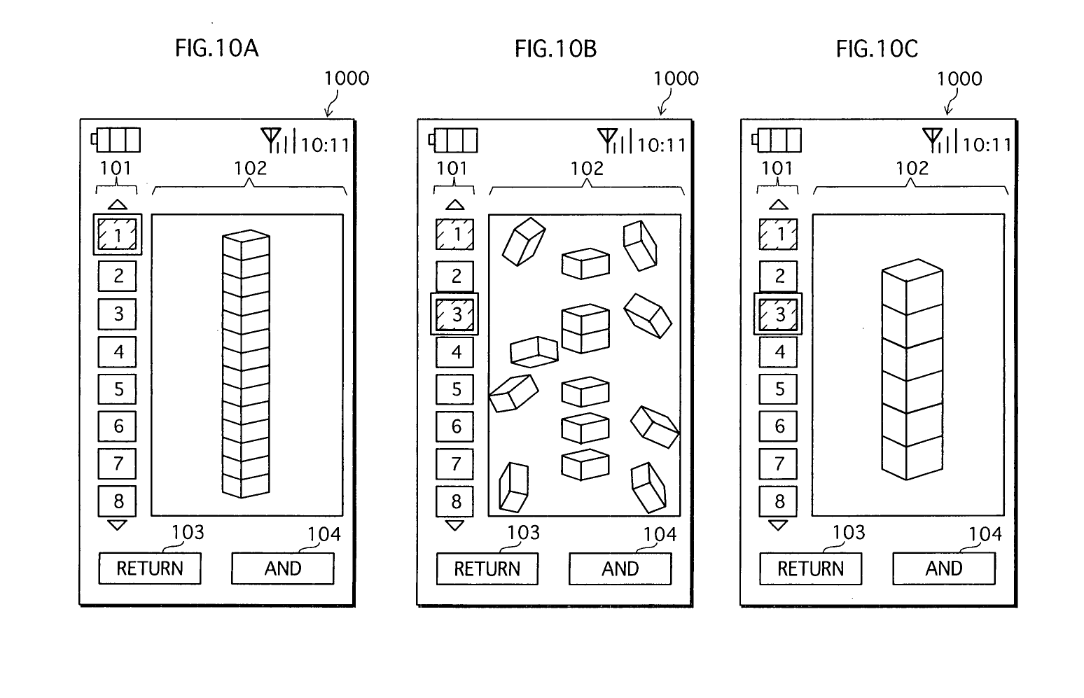

The display control unit 19 specifically display the search results by means of the display control unit 19, in such a manner as shown in FIGS. 10A, 10B, and 10C.

Each of FIGS. 10A, 10B, and 10C is a diagram showing a search screen 1000 that the display unit 16 displays, in response to searching of the telephone book performed by a user.

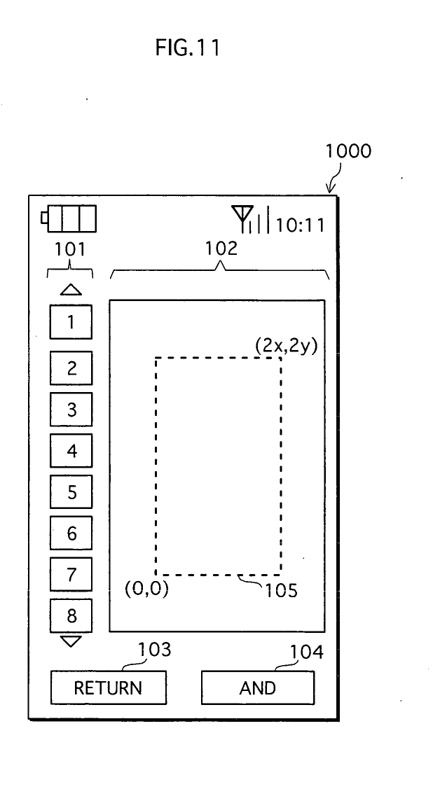

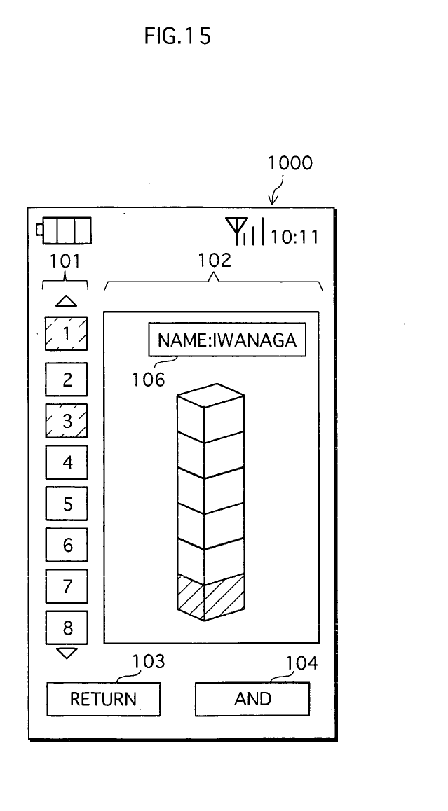

As shown in this drawing, the search screen 1000 contains a group selection portion 101, a search result display portion 102, an operation cancellation portion 103, a search condition change portion 104, a first area 105 (of FIG. 11) and an attribute information display portion 106 (of FIG. 15).

The group selection portion 101 receives a user operation to select a group. A user moves a cursor by pushing the up key 20 and the down key 22, to select an image showing a group number. An image that the user is currently selecting is displayed larger than the other images. When the function key 24 is pushed on the selected image, a group corresponding to the selected image is selected. When the user selects a group, the image corresponding to the group is highlighted, indicating that the group is currently selected by the user. In the example of FIG. 10A, the user is currently selecting the group 1, and so the image representing the group 1 is displayed larger than the other images, and in the highlighted manner.

Note that if an operation to select a once selected group is performed again, it triggers a NOT search by which the parties not included in the selected group is searched for. Although not illustrated, it is optionally possible to indicate that the selected group is subjected to a NOT search, by showing the corresponding image overlaid with a mark of × for example, or by changing the color of the corresponding image.

The search result display portion 102 is for displaying a search result. In the example of FIG. 10A, the group 1 is currently being selected by the user, and so the parties included in the group 1 are displayed in the search result display portion 102. Each party is represented by an icon having the form of a cuboid. Each image of icon is stored in the storage unit 15 in advance. In this example, by selecting the group 1, fourteen search results corresponding to the parties included in the group 1 are outputted, and fourteen icons respectively corresponding to the fourteen parties are displayed.

The operation cancellation portion 103 is used when the user would like to cancel a once designated search condition. The user is able to perform a cancellation operation directed to a search condition by pushing the left soft key 27.

The search condition change portion 104 is used to change a search condition. A user is able to change a search condition by pushing the right soft key 28. Specifically, a user can switch between an AND search and an OR search. In the example of the drawing, the search condition change portion 104 is displaying “AND”, meaning that the AND search is currently being designated.

The first area 105 in FIG. 11 is a part of the search result display portion 102, and is for displaying icons respectively corresponding to the found search results. As shown in this drawing, the first area 105 has a coordinates system having a unit of pixels, whose limits correspond to the lowest left coordinates of (0,0) and the highest right coordinates of (2X, 2Y). Based on this coordinates system, the display control unit 19 controls a position at which an icon is to be displayed in the first area 105.

The attribute information display portion 106 in FIG. 15 is for displaying attribute information corresponding an icon displayed in the search result display portion 102. A user is able to move the cursor that is on the group selection portion 101, to the search result display portion 102 by performing an operation to push the right key 23. A currently selected icon is highlighted so as to be distinguishable from the other icons. In addition the attribute information corresponding to the selected icon is displayed in the attribute information display portion 106. The user is able to select other icons by pushing the up key 20 and the down key 22, and is further able to move the cursor to the group selection portion 101 by pushing the left key 21. In the example of the drawing, an icon positioned the lowest of the first area 105 among all the icons is currently selected, and from the attribute information corresponding to the selected icon, the name 32 is displayed in the attribute information display portion 106.

<Processing to Decide a Display Method of Search Results>

As follows, processing performed by the display control unit 19 in Step S92 is described with reference to related drawings. In Step S92, the display control unit 19 decides how to display search results to the display unit 16, in accordance with the number of extracted search results, and actually displays the search results according to the decided method.

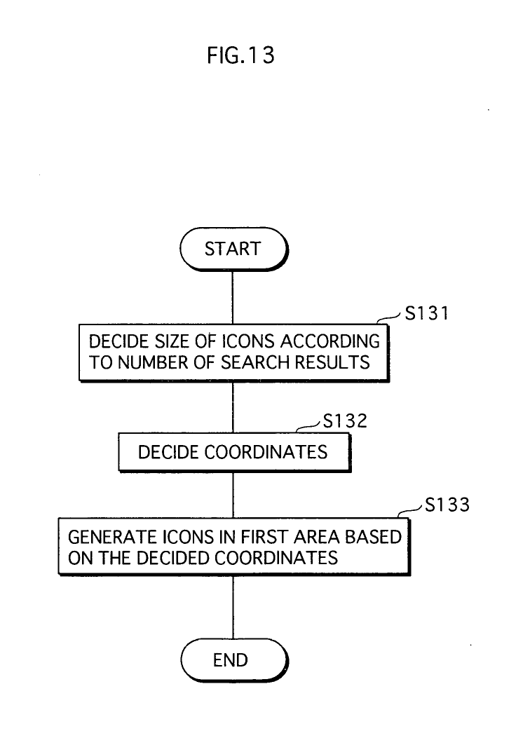

FIG. 13 is a flowchart showing processing performed by the display control unit 19 in response to the user's selection of the first group.

When the user has selected the first group, the display control unit 19 decides the size of the icons to be displayed in the first area 105 of the search result display portion 102, in accordance with the number of extracted search results (Step S131). For example if there are fourteen extracted search results, the size of the displayed icons is decided to be 2(length)×2(width) pixels. The size of icons is set in advance according to the number of pieces of extracted results.

Once the size of the icons is decided, display coordinates of the icons in the first area 105 are decided (Step S132). The decided coordinates are stored in the storage unit 15 after being associated with corresponding search results having been stored in the storage unit 15.

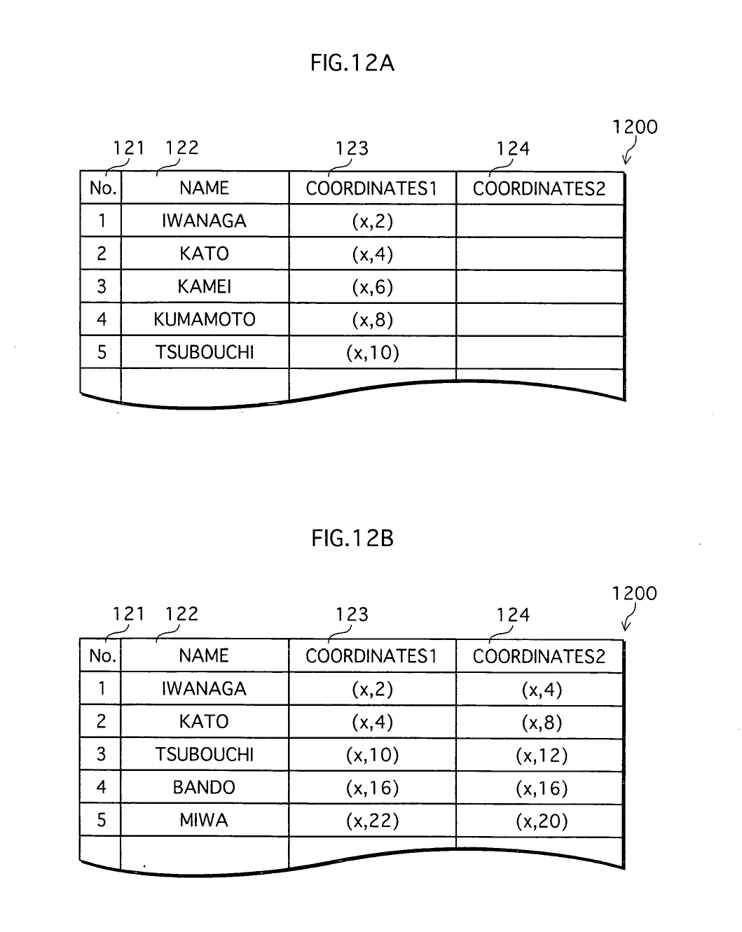

This is detailed as follows using the related drawings. FIGS. 12A and 12B illustrate a search result storage table 1200 stored in the storage unit 15. The search result storage table 1200 includes items of: address 121 representing an address of a corresponding piece of attribute information; name 122 representing a name of a party corresponding to the piece of attribute information; and first coordinates 123 and second coordinates 124 both representing coordinates of the first area 105 at which an icon associated with the piece of attribute information is to be displayed. The coordinates decided in Step S132 are stored under the item of the first coordinates 123 (“coordinates 1” of FIG. 12A).

After storing the coordinates of icons under the item of the first coordinates 123, the display control unit 19 generates icons associated with found pieces of attribute information and displays the icons to the first area 105, according to the stored coordinates (Step S133).

In this way, the icons for the pieces of attribute information found in the search directed to the first group are successfully displayed on the first area 105, as the search results.

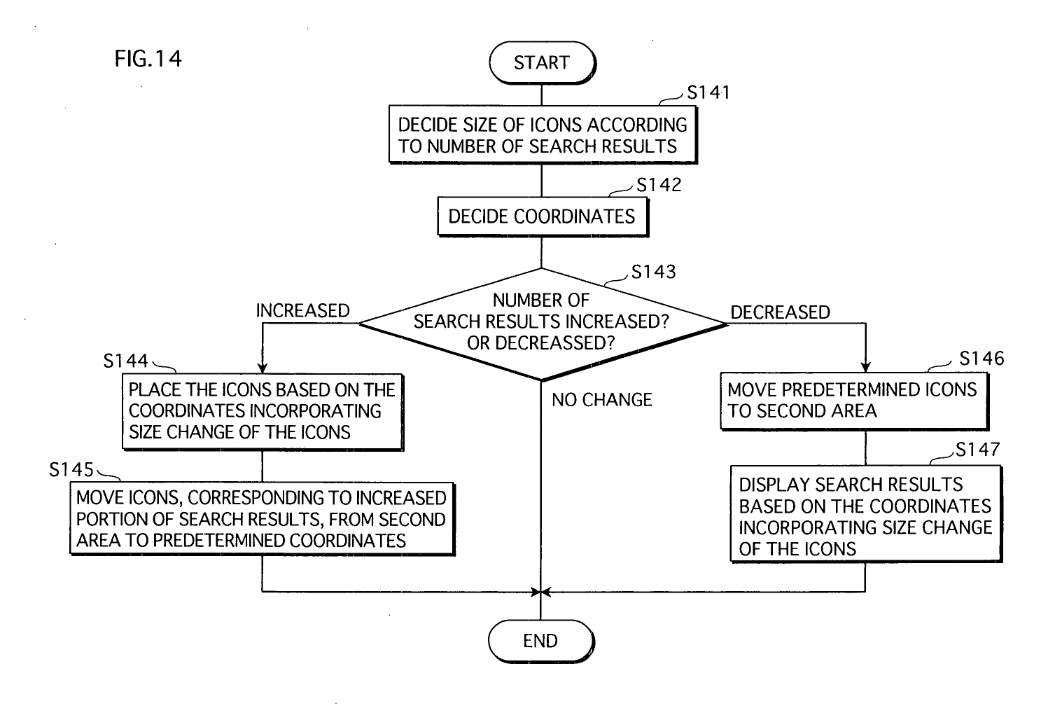

Next, the processing performed to control a display method of icons when the user selects a new group or changes the search conditions is detailed, with reference to FIG. 14. Specifically, the display method of icons is controlled so that the icons are displayed in the first area 105 according to the number of pieces of attribute information found as the new search results.

FIG. 14 is a flowchart showing processing to control the display method of icons that the display control unit 19 displays in the search result display portion 102 every time search results are outputted.

Note that in the following description, search results having been outputted prior to a new group selection by a user, or search results having been outputted prior to a change in search condition are referred to as “first search results”. Meanwhile search results newly outputted after the new group selection, or search results outputted after the change in search condition are referred to as “second search results”.

When the search control unit 18 has outputted the second search results, the display control unit 19 decides the size of icons to be displayed on the first area 105 of the search result display portion 102, in accordance with the number of the outputted second search results (Step S141).

After the size of the icons has been decided, coordinates of the icons in the first area 105 are respectively decided (Step S142). The decided coordinates are stored in the search result storage table 1200 under the item of second coordinates 124 of the search result storage table 1200. Note that the coordinates stored under the first coordinates 123 are the coordinates having been stored respectively in association with the first search results.

When the coordinates of the icons in the first area 105 are decided, it is then judged whether the number of search results has been increased or decreased due to the new group selection or due to the change in search condition (Step S143).

When it is judged that the number of search results has increased (Step S143: INCREASE), the icons are arranged so that the size of the icons displayed in the first area 105 is changed to the size decided in Step S141, and so that the icons are changed, in position, from the coordinates stored under the first coordinates 123 to the coordinates stored under the second coordinates 124 in Step S142 (Step S144).

When the above-described arrangement of icons is complete, icons corresponding to the increased portion of search results are generated in the second area, and the generated icons are then moved to the coordinates stored in the second coordinates 124 (Step S145).

Note that one example method of generating the icons corresponding to the difference between the new search results (second search results) and the old search results (first search results) is to decide the coordinates thereof in the second area by means of random numbers. The icons may be moved linearly from the coordinates in the second area to the coordinates having been stored in the second coordinates 124. Needless to say, other methods may be adopted in moving the icons.

When it is judged that the number of search results has decreased in Step S143 (Step S143:DECREASE), icons corresponding to the decreased portion of search results are moved out to the second area (Step S146). The icons moved out to the second area are eventually deleted from the search result display portion 102. In deleting the icons, the icons may seem to extinguish from the screen, or may seem to be as if they are leaving out from the screen.

Once predetermined icons have been moved to the second area, the size of the icons remaining in the search result display portion 102 is changed to the one having been decided in Step S141, and the remaining icons are changed from the coordinates stored under the first coordinates 123 to the coordinates stored under the second coordinates 124 (Step S147).

When there is no increase/decrease in the number of search results in Step S143, no processing (e.g. moving of icons) is performed.

In this way, after the second search results have been displayed in the first area 105, the coordinates of each piece of attribute information in the second search results stored under the second coordinates 124 is copied to under the first coordinates 123, and thereafter the contents having been stored under the second coordinates 124 is deleted.

The above-described moving processing of each icon performed every time new search results are outputted is specifically performed in the manner shown in FIGS. 10B and 10C, for example.

FIG. 10B is a diagram showing the manner in which each icon moves from the first area 105 to the second area. This drawing shows a search for parties belonging to both of the group 1 and the group 3, in response to the user's selection of the group 3 in addition to the former selected group 1. Due to the selection of the group 3, eight icons representing the parties, who belong to the first search results but do not belong to the second search results, are being moved to the second area.

After the moving of icons is complete, the new search results are displayed as shown in FIG. 10C.

<Call Processing>

As described above, the user is able to select each displayed icon, and to confirm attribute information displayed in the attribute information display portion 106. The user is also able to perform collective mail transmission, PTT communication, and the like, to the entire found parties. Furthermore, the user is able to remove the attribute information of a party corresponding to the selected icon, from the search results. Incident to removal of an icon, the attribute information of the party corresponding to the removed icon is deleted from the search result storage table 1200, and the size and the coordinates of the icons to still remain in the first area 105 are decided in accordance with the number of the remaining icons. The decided coordinates are stored under the second coordinates 124 of the search result storage table 1200. Then the icons to still remain on display are disposed in accordance with corresponding coordinates stored under the second coordinates 124. Thereafter, the coordinates stored under the second coordinates 124 are moved to under the first coordinates 123, and the contents stored under the second coordinates 124 is deleted.

Furthermore, the storage unit 15 is capable of retaining the address 121 of a piece of attribute information corresponding to the icon that is being currently selected by the user from among the search results stored in the search result storage table 1200. When the user pushes the up key 20 and the down key 22, the value of the retained address 121 is incremented by a predetermined amount. The display control unit 19 performs processing such as highlighting, by identifying the icon being currently selected by the user with reference to the value of the address 121 retained in the storage unit 15.

### MODIFICATION EXAMPLES

So far, the present invention has been described by way of an embodiment. However needless to say, the present invention should not be limited to the above-described embodiment. For example, the following modifications are possible.

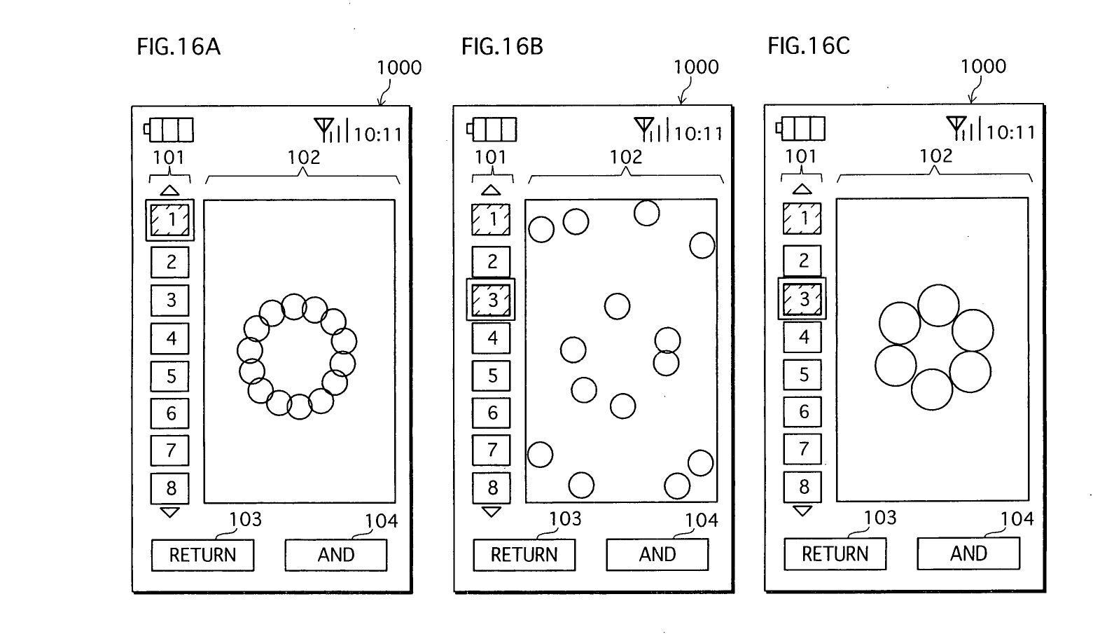

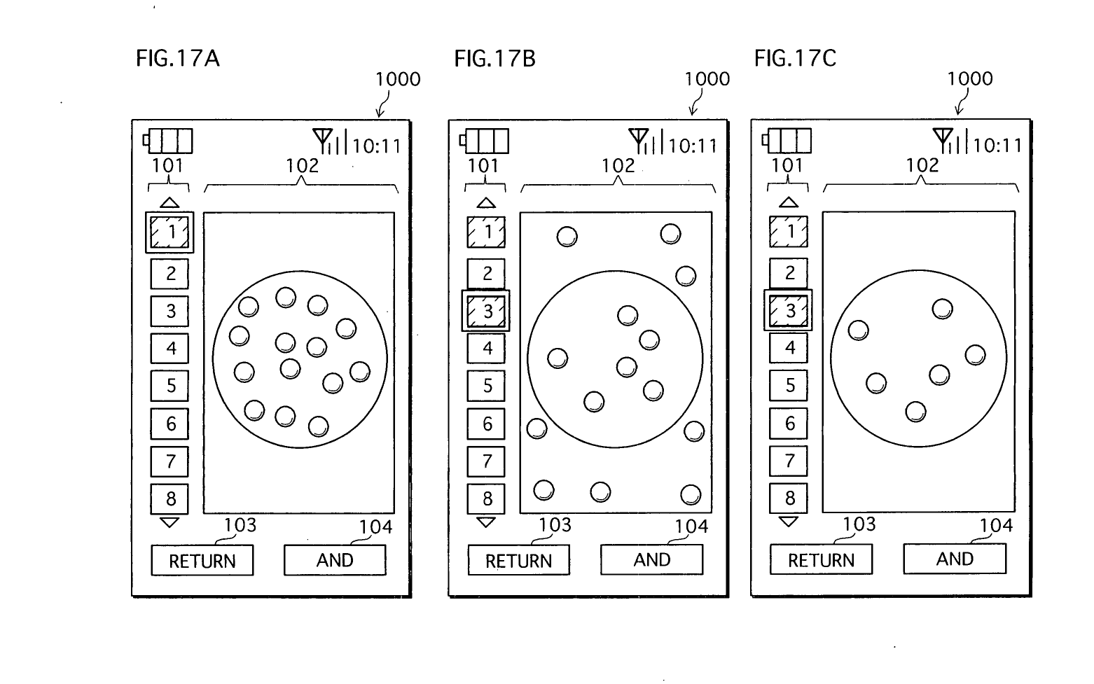

(1) In the above-described embodiment, each icon representing a party has a form of cuboid, but may be other figures, characters, and marks. In addition, an icon may be a three-dimensional shape of any of such figures, characters, and marks. For example, an icon may have a circular form as shown in FIGS. 16A, 16B, and 16C. Moreover, an icon may have a spherical form, as shown in FIGS. 17A, 17B, and 17C. Moreover, in the case where the storage unit 15 is designed to store pieces of image data in association with parties respectively, the pieces of image data may be displayed as the icons.

(2) In the above-described embodiment, icons representing the search results are displayed in a one dimensional linear formation, as illustrated in FIG. 15. However, it is alternatively possible to display icons in a circular formation as shown in FIG. 16A and in FIG. 16C. It is still alternatively possible to display icons in a random formation as shown in FIG. 17A or FIG. 17C. So as to realize display in the random formation, one possible method is to decide the coordinates in which the icons are to be placed using random numbers. Even when the icons are displayed in a random formation, the search results are stored in the search result storage table 1200 and that the address 121 of the piece of attribute information corresponding to the icon currently selected by the user is retained in the storage unit 15, allowing the user to be able to sequentially select the icons by push of the up key 20 and the down key 22.

(3) In the above-described embodiment, every time a new search condition is designated, icons are moved between the first area 105 and the second area. However this function of moving icons between the areas is not an essential requirement of the present invention. In fact, the present invention includes a case of deleting icons after being moved within the first area 105, for example.

(4) In the above-described embodiment, the attribute information display portion 106 is designed to display the name 32 as the attribute information corresponding to the icon currently being selected by the user. However alternatively, the attribute information display portion 106 may display the telephone number 33 or the mail address 34, as the attribute information corresponding to the icon currently being selected by the user.

(5) In the above-described embodiment, the size of the icons to be displayed is decided according to the number of found search results. However not limited to this structure, the size of the icons may be fixed. Alternatively, an icon collectively representing several parties may be adopted. For example, an icon may represent ten parties.

(6) The present invention may be any of the methods described above. Furthermore, the present invention may be a computer program that realizes any of the methods on the mobile telephone. Still further, the present invention may be a digital signal(digital signals) made of the computer program.

In addition, the present invention may be the program or the digital signal(s) stored in a computer-readable recording medium such as a flexible disk, a hard disk, a CD-ROM, a MO, a DVD, a DVD-ROM, a DVD-RAM, a BD (Blu-ray Disc), and a semiconductor memory. Moreover, the present invention may be such a computer-readable recording medium storing the computer program or the digital signal(s).

Furthermore, in the present invention, the computer program or the digital signal(s) may be conveyed via a network represented by an electric communication circuit, wired/wireless communication circuits, and the Internet, via data broadcast, and the like.

(7) The present invention may be a combination of any of the embodiment and the modification examples.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A mobile telephone, comprising:
a storage unit pre-storing therein pieces of attribute information in one-to-one relation with parties to be communicated with;
a designation reception unit operable to receive, from a user, designation of a search condition for searching the pieces of attribute information;
an extraction unit operable to extract, from the storage unit, one or more pieces of attribute information that satisfies the search condition;
a display control unit operable to: when first designation is received, display on a predetermined area of a display, a first set of marks corresponding to pieces of attribute information extracted in accordance with the first designation; and when second designation is received succeeding the first designation, a) display on the predetermined area, a second set of marks corresponding to pieces of attribute information extracted in accordance with the second designation, and b) display in a predetermined display manner, and thereafter delete a third set of marks that correspond to a difference between the first set of marks and the second set of marks; and
a selection information display unit operable to select, according to a user operation, any mark displayed on the predetermined area, and to display at least part of a piece of attribute information corresponded with the mark.

2. The mobile telephone of claim 1, wherein
the display control unit displays the first set of marks on a first area of the display, the second set of marks on the first area, and the third set of marks on a second area of the display that is outside the first area.

3. The mobile telephone of claim 1, wherein
the storage unit stores the pieces of attribute information in association with one or more groups, respectively,
designation received by the designation reception unit is selection of at least one group and a logical operator, and
the extraction unit performs the extraction based on the at least one group and the logical operator selected by the designation reception unit.

4. The mobile telephone of claim 1, wherein
the storage unit stores each of the pieces of attribute information in association with corresponding image data, and
each mark displayed by the display control unit is image data stored in the storage unit in association with a corresponding piece of attribute information.

5. The mobile telephone of claim 1, wherein
the display control unit determines a displayed size of marks corresponding to pieces of attribute information extracted at one time, according to a number of the pieces of attribute information extracted at one time, and displays the marks in the determined size.

6. The mobile telephone of claim 2, wherein
the display control unit displays the first set of marks and the second set of marks respectively on the first area in one row, and moves the third set of marks between the first area and the second area as if the third set of marks is either departing from or joining the row.

7. The mobile telephone of claim 2, wherein
the display control unit displays the first set of marks and the second set of marks respectively on the first area in a circular formation, and moves the third set of marks between the first area and the second area as if the third set of marks is either departing from or joining the circle.

8. The mobile telephone of claim 1, wherein
each of the pieces of attribute information includes a name, a telephone number, and a mail address, as attributes of a corresponding party to be communicated with, and
the selection information display unit displays, for each selected mark, at least one of a name, a telephone number, and a mail address.
